(19) United States
(12) Patent Application Publication
(10) Pub. No.: US 2010/0140028 A1
(43) Pub. Date: Jun. 10, 2010

(54) Electronic Wedge Brake System

(75) Inventors: In Su KIM, Hwangsung-si (KR); Hyun Soo Kim, Gwacheon-si (KR); Nam Young o Cho, Seoul (KR); Chi Hoon Jo, Suwon-si (KR); Sang Mok Lee, Geochang-gun (KR); Han Lim Song, Seoul (KR)

Correspondence Address: MORGAN, LEWIS & BOCKIUS LLP (SF), One Market, Spear Street Tower, Suite 2800, San Francisco, CA, 94105, US

(73) Assignees: Hyundai Motor Company, Seoul (KR); Sungkyunkwan University Foundation for Corporate Collaboration, Jangan-gu (KR)

(21) Appl. No.: 12/507,579

(22) Filed: Jul. 22, 2009

(30) Foreign Application Priority Data
Dec. 5, 2008 (KR) 10-2008-0123655

(51) Int. Cl. F16D 55/08

(52) U.S. Cl. 188/72.7

(57) ABSTRACT

An electronic wedge brake system includes an upper wedge member, one end portion of which is coupled to an inner pad provided to one side of a disc, and the other end portion of which defines an upper wedge surface thereon, a lower wedge member disposed adjacent to the upper wedge member and connected to a stationary member, the lower wedge member defining a lower wedge surface thereon in a side facing the upper wedge surface, at least a wedge roller provided between the upper and lower wedge surfaces, a roller grip plate slidably coupled to the upper wedge member for guiding a motion of the upper wedge member, and an actuator coupled to the stationary member and the roller grip plate and configured to selectively move the roller grip plate and the upper wedge member so that the inner pad can be engaged to or disengaged from the disc.

### CLAIM OF PRIORITY

The present application claims priority to Korean Patent Application Number 10-2008-123655 filed Dec. 5, 2008, the entire contents of which application is incorporated herein for all purposes by this reference.

### BACKGROUND OF THE INVENTION

1. Field of the Invention

The present invention relates to an electronic wedge brake.

2. Description of Related Art

As a conventional caliper brake, an electronic wedge brake system is used.

FIG. 1 is a schematic cross-sectional view illustrating a conventional electronic wedge brake system.

Referring to FIG. 1, the conventional electronic wedge brake system includes a disc 10 provided inside a caliper 5 to rotate along with a vehicle wheel, inner and outer pads 12a and 12b provided adjacent to both sides of the disc 10, respectively, an upper wedge member 14 coupled with the inner pad 12a, a lower wedge member 16 with one end 16a connected to the outer pad 12b and with the other end 16b facing the upper wedge member 14, and wedge rollers 18a placed between the upper wedge member 14 and the lower wedge member 16.

Upper and lower wedge surfaces 15 and 17 facing each other are formed on opposite surfaces of the upper and lower wedge members 14 and 16, respectively.

A drive unit 24 is provided on the lower wedge member 16 to move the lower wedge member 16 to the right or left.

Below, a description will be given of the operation of the convention electronic wedge brake system having the aforementioned construction.

When the brake system is activated, the drive unit 24 acts to push the lower wedge member 16 to the right (in the direction of a first arrow 31). As the lower wedge member 16 moving to the right, the wedge rollers 18a move between the upper and lower wedge surfaces 15 and 17, causing the upper wedge surface 15 to be spaced further apart from the lower wedge surface 17.

As a result, the upper wedge member 14 together with the inner pad 12a moves towards the disc 10 to push the inner pad 12a against the lower surface of the disc 10, and the lower wedge member 16 together with the outer pad 12b moves towards the disc 10 to push the outer pad 12b against the upper surface of the disc 10.

However, in the conventional electronic wedge brake system as mentioned above, the drive unit is required to continuously operate so that a force can be continuously applied to the lower wedge member. In consequence, the drive unit consumes a great amount of power without directly applying a force to the upper wedge member.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide an electronic wedge brake system, which is constructed to directly transmit a force to an upper wedge member so that a drive unit does not spend a great amount of power.

In an aspect of the present invention, the electronic wedge brake system may include an upper wedge member, one end portion of which is coupled to an inner pad provided to one side of a disc, and the other end portion of which defines an upper wedge surface thereon, a lower wedge member disposed adjacent to the upper wedge member and connected to a stationary member, the lower wedge member defining a lower wedge surface thereon in a side facing the upper wedge surface, at least a wedge roller provided between the upper and lower wedge surfaces, a roller grip plate slidably coupled to the upper wedge member for guiding a motion of the upper wedge member, and an actuator coupled to the stationary member and the roller grip plate and configured to selectively move the roller grip plate and the upper wedge member so that the inner pad can be engaged to or disengaged from the disc.

The actuator may include a threaded rod connected to a drive motor to apply a rotational force to the roller grip plate, wherein the stationary member includes a coupler that integrally couples the drive motor with the lower wedge member, wherein the roller grip plate has grip threads formed therein, the grip threads being engaged with the threaded rod and, wherein the threaded rod includes a ball bearing screw which has drive threads engaging with the grip threads of the roller grip plate.

In another aspect of the present invention, the roller grip plate may define therein a guide slot and a portion of the upper wedge member is slidably coupled thereto for guiding an upward and downward motion of the upper wedge member, wherein the upper wedge member has a wedge roller lug slidably coupled to the guide slot of the roller grip plate.

In further another aspect of the present invention, the at least a wedge roller may be rotatably connected by a connecting rod.

According to various aspects of the present invention, since the drive motor directly supplies a force to the upper wedge member via the roller grip plate, the force can easily and efficiently transmitted. In addition, since the force is transmitted via threads, it is not required to continuously transmit power to maintain a braking force. This as a result ensures effects such as a decrease in the required torque of the motor and an increase in power transmission efficiency.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a schematic cross-sectional view illustrating a conventional electronic wedge brake system.

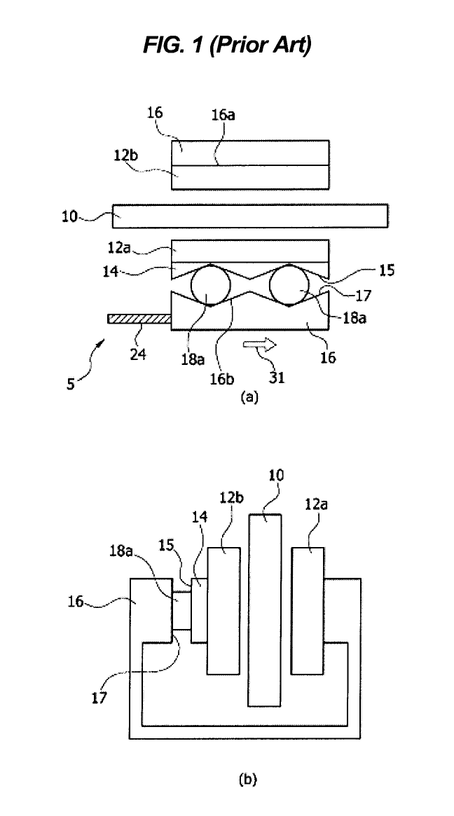

FIG. 2 is a cross-sectional view illustrating an exemplary electronic wedge brake system according the present invention.

FIG. 3 is a cross-sectional view illustrating the operating state of the electronic wedge brake system shown in FIG. 2.

FIG. 4 is an enlarged perspective view illustrating important parts of the electronic wedge brake system shown in FIG. 2.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

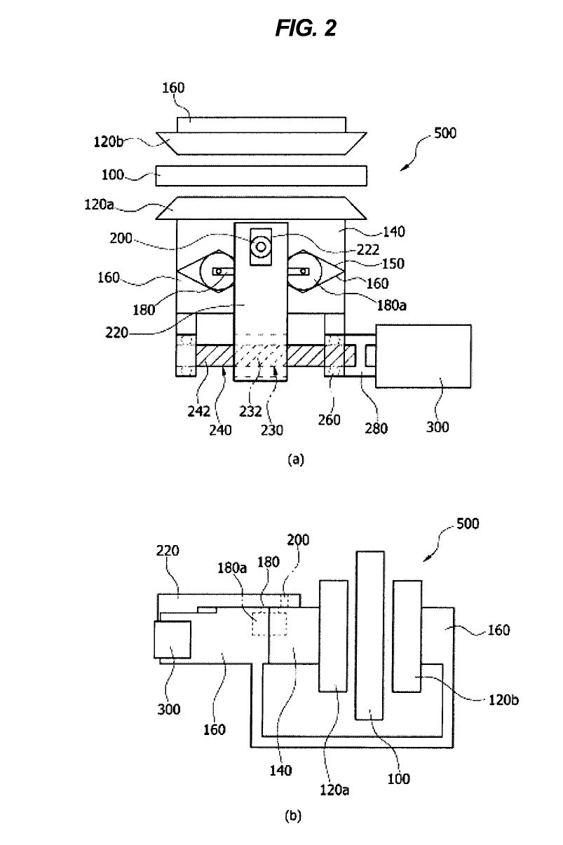

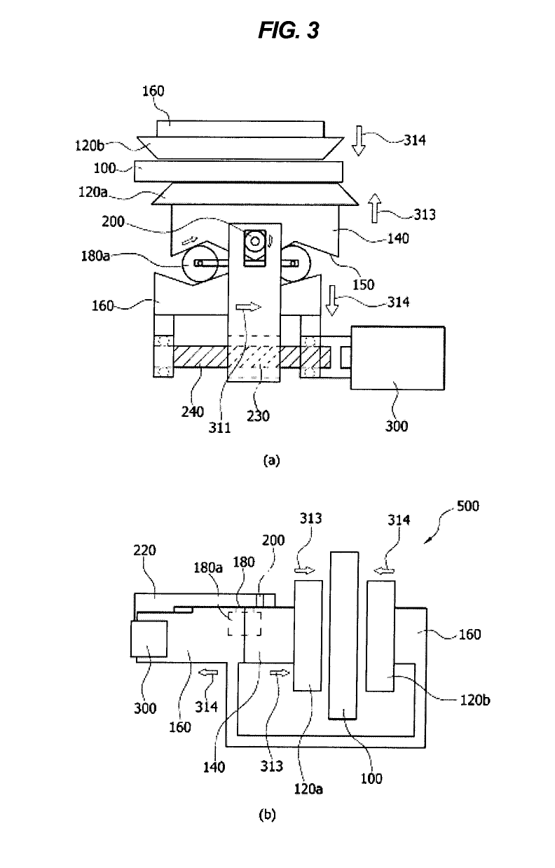

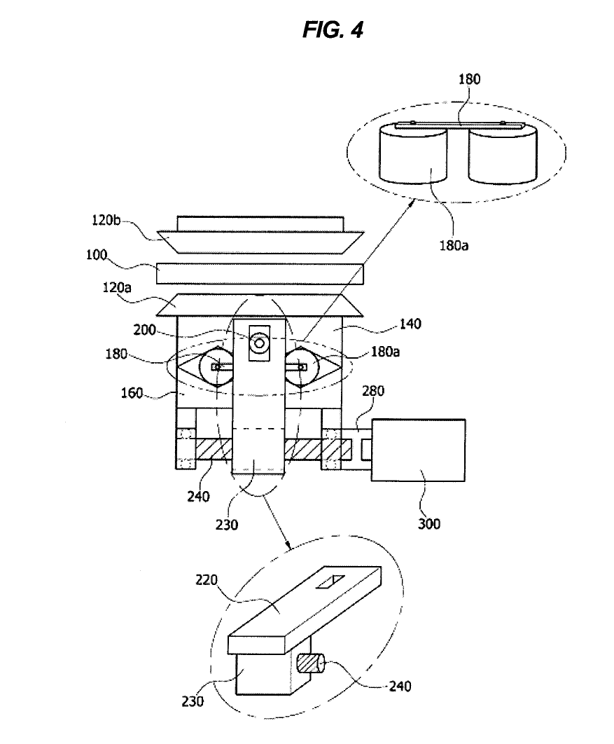

FIG. 2 is a cross-sectional view illustrating an electronic wedge brake system according to various embodiments of the present invention, FIG. 3 is a cross-sectional view illustrating the operating state of the electronic wedge brake system shown in FIG. 2, and FIG. 4 is an enlarged perspective view illustrating important parts of the electronic wedge brake system shown in FIG. 2.

The electronic wedge brake system of various embodiments includes a disc 100 provided inside a caliper 500 to rotate along with a vehicle wheel, inner and outer pads 120a and 120b provided on both sides of the disc 100, respectively, an upper wedge member 140 coupled with the inner pad 120a, and a lower wedge member 160 with one end coupled with the outer pad 120b and with the other end provided adjacent to the upper wedge member 140.

The upper wedge member 140 has an upper wedge surface 150 facing the lower wedge member 160. The upper wedge member 140 also has a wedge roller lug 200 extending in a direction perpendicular to a horizontal direction. The direction perpendicular to a horizontal direction includes a forward-backward direction in which the upper wedge member 140 advances towards and retreats from the disc 100.

The lower wedge member 160 has a lower wedge surface 160 in a position facing the upper wedge surface 150.

A plurality of wedge rollers 180a are provided between the upper and lower wedge surfaces 150 and 160 and are connected with each other via a rod-shaped roller-connecting member 180.

The roller-connecting member 180 allows the wedge rollers 180a to operate as a unitary body.

In addition, the electronic wedge brake system of various embodiments includes a roller grip plate 220, a ball bearing screw 240 and a drive motor 300. Here, the roller grip plate 220 has a slot-shaped guide 222 formed along the forward-backward direction to guide the wedge roller lug 200. The roller grip plate 220 includes a guide block 230 provided on the underside thereof, and the guide block 230 has grip threads 232 formed in the inner circumference thereof. The ball bearing screw 240 has drive threads 242 engaging with the grip threads 232. The drive motor 300 applies a driving force to the ball bearing screw 240.

The drive motor 300 is coupled with the lower wedge member 160 via a coupler 280, thereby forming a unitary body. The coupler 280 is connected via a coupler bearing 260 with the ball bearing screw 240, which is provided in parallel to the lower wedge member 160.

The wedge rollers 180a are placed between grooves of the upper wedge surface 150 and the lower wedge surface 160 when the brake system is not activated. When the brake system is activated, the wedge rollers 180a move along with the upper wedge surface 150, causing the upper wedge surface 150 to be spaced further apart from the lower wedge surface 160.

Below, a description will be given of the operation of the electronic wedge brake system of various embodiments having the aforementioned construction.

When a driver steps on a brake pedal, as shown in FIG. 3, the drive motor 300 causes the ball bearing screw 240 to rotate, and thus the roller grip plate 220 is moved in the direction of a rightward arrow 311 via the grip threads 232 engaging with the drive threads 242 of the ball bearing screw 240.

The wedge roller lug 200 placed inside the guide 222 of the moving roller grip plate 220 is forced to the right by the guide 222, and the upper wedge member 140 having the wedge roller lug 200 is forced to move in the same direction.

Here, the wedge rollers 180a are moved to separate the upper wedge surface 150 further apart from the lower wedge surface 160 and, in consequence, the upper wedge member 140 is moved in the direction of a forward arrow 313, pushing the inner pad 120a against the disc 100.

In addition, one end of the lower wedge member 160 is moved in the direction of a rearward arrow 314, pushing the outer pad 120b against the disc 100.

According to various embodiments of the present invention as set forth above, since the drive motor directly supplies a force to the upper wedge member via the roller grip plate, the force can easily and efficiently transmitted. In addition, since the force is transmitted via threads, it is not required to continuously transmit power to maintain a braking force. This as a result ensures effects such as a decrease in the required torque of the motor and an increase in power transmission efficiency.

For convenience in explanation and accurate definition in the appended claims, the terms “upper”, “lower”, “outer”, and “inner” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof It is intended that the scope of the invention be defined by the Claims appended hereto and their equivalents.

What is claimed is:

1. An electronic wedge brake system comprising:
an upper wedge member, one end portion of which is coupled to an inner pad provided on one side of a disc, and the other end portion of which defines an upper wedge surface thereon;
a lower wedge member positioned adjacent the upper wedge member and connected to a stationary member, the lower wedge member defining a lower wedge surface thereon in a side facing the upper wedge surface;
at least a wedge roller provided between the upper and lower wedge surfaces;
a roller grip plate slidably coupled to the upper wedge member for guiding a motion of the upper wedge member; and
an actuator coupled to the stationary member and the roller grip plate and configured to selectively move the roller grip plate and the upper wedge member so that the inner pad can be engaged to or disengaged from the disc.

2. The electronic wedge brake system according to claim 1, wherein the actuator includes a threaded rod connected to a drive motor to apply a rotational force to the roller grip plate.

3. The electronic wedge brake system according to claim 2, wherein the stationary member includes a coupler that integrally couples the drive motor with the lower wedge member.

4. The electronic wedge brake system according to claim 2, wherein the roller grip plate has grip threads formed therein, the grip threads being engaged with the threaded rod.

5. The electronic wedge brake system according to claim 4, wherein the threaded rod includes a ball bearing screw which has drive threads engaging with the grip threads of the roller grip plate.

6. The electronic wedge brake system according to claim 1, wherein the roller grip plate defines therein a guide slot and a portion of the upper wedge member is slidably coupled thereto for guiding an upward and downward motion of the upper wedge member.

7. The electronic wedge brake system according to claim 6, wherein the upper wedge member has a wedge roller lug slidably coupled to the guide slot of the roller grip plate.

8. The electronic wedge brake system according to claim 1, wherein the at least a wedge roller are rotatably connected by a connecting rod.
